(19) United States
(12) Patent Application Publication
(10) Pub. No.: US 2019/0317383 A1
(43) Pub. Date: Oct. 17, 2019

(54) IMAGE CAPTURE APPARATUS

(71) Applicant: Light Revolution Limited, Reading (GB)

(72) Inventor: Patrick David Llewelyn-Davies, Reading (GB)

(21) Appl. No.: 15/839,367

(22) Filed: Dec. 12, 2017

(51) Int. Cl. G03B 15/02; H04N 5/225; H04N 5/235; G03B 17/56

(52) U.S. Cl. CPC G03B 15/02; G03B 17/561; H04N 5/2354; H04N 5/2253

(57) ABSTRACT

Apparatus for capturing a still or moving image of an object (5) comprises a camera (2) pointed at the object, and at least one light source (22) illuminating the object. The apparatus includes means (19) for mounting the light source (22) such that it is capable of being moved around the object (5) in a non-linear path. The mounting means (19) includes an adjustment mechanism allowing the light source (22) to be mounted at a variety of different heights relative to the object (5). A motor (17) drives the light source (22) around the object.

### BACKGROUND

Traditionally, “pack shots” of products for advertising images are produced using a camera, one or more light sources, and various reflectors or shades to modify the lighting effect. The image of the product is taken with a white background, and the white background is then digitally removed to leave the product image on a transparent background for placement within an advertising image. Other more artistic techniques include “painting with light”, in which a camera with a slow shutter speed is situated in a dark room, and the object to be photographed is illuminated with a hand-held light source which is moved around by hand to illuminate parts of the object at a time. The present invention attempts to provide a practical and repeatable system for producing creative lighting effects, which is more predictable and efficient than “painting with light”.

### SUMMARY

This invention relates to a method and apparatus for capturing an image, whether a still or moving image. This apparatus is capable of producing soft, shadowless high-end images, suitable for use in advertising or any other circumstances where high definition images are required.

### BRIEF DESCRIPTION OF THE DRAWINGS

The invention will be further described, by way of example only, with reference to the accompanying drawings, in which:

FIG. 1 is a schematic side view of image capture apparatus according to the present invention,

FIG. 2 is a schematic side view of an alternative embodiment of image capture apparatus according to the present invention,

FIG. 3 is a schematic side view of a further embodiment of image capture apparatus according to the present invention,

FIGS. 4 is a perspective view of an arm used in a further embodiment of image capture apparatus according to the present invention,

FIG. 5 is a perspective view of an arm used in yet another embodiment of image capture apparatus according to the present invention,

FIG. 6 is a perspective view of a motorised arm that can be used in a further embodiment of the image capture apparatus according to the present invention, and

FIG. 7 is a schematic diagram of a process according to the present invention that uses an image capture apparatus.

### DETAILED DESCRIPTION

There is provided apparatus for capturing a still or moving image of an object, the apparatus comprising;
a) a camera pointed at the object;
b) at least one light source illuminating the object;
c) means for mounting the at least one light source such that it is capable of being moved around the object in a non-linear path, the mounting means including an adjustment mechanism allowing the at least one light source to be mounted at a variety of different heights relative to the object; and
d) drive means for driving the at least one light source around the object.

Optical inspection systems have been proposed such as those described in U.S. Pat. Nos. 4,172,524 and 5,774,212 in which one or more light sources are rotated around an object in order to illuminate it from all sides. However, these systems only allow the light sources to be positioned at one particular height with respect to the object to be investigated. The present invention includes an adjustment mechanism which allows the one or more light sources to be mounted at different heights with respect to the object. This variation in illuminating height and angle allows for a large amount of different optical effects to be obtained, something which is irrelevant in inspection techniques which have a scientific rather than artistic goal.

Preferably, the at least one light source is mounted on an arm which is movable about the object. The adjustment mechanism is typically part of this arm allowing the or each light source to be mounted at different heights on the arm. Arms are not the only means for mounting the at least one light source for movement around the object, and other arrangements such as holders moving on a track or rail can be easily envisaged. However, where the mounting means does comprise at least one arm, the arm is conceivably provided with adjustment means so as to vary the distance of the light source from the object. This adjustment means (which is different from the adjustment mechanism for varying the height of the at least one light source), varies the distance of the light source from the object. This means that different non-linear paths can be constructed for the light source moving around the object.

In one sophisticated arrangement, the apparatus includes a motor for activating the adjustment means so as to vary the distance of the light source from the object while the drive means is driving the at least one light source around the object. In this way, the light source can move around the object in a variety of paths, such as in an elliptical path. More commonly, however, the mounting means is such that the at least one light source can be moved around the object in a circular path. Where the light source moves in a circular path, the adjustment means can still be used to vary the radius of the circular path, either between shots or during a shoot, with the circular path either increasing or decreasing in radius.

The apparatus conveniently includes a stationary platform on which the object can be placed, with the drive means driving the at least one light source around the platform. In this way, the object to be photographed is located in a known position on the platform, with the camera and light source oriented with respect thereto. The drive means preferably drives the at least one light source around the object at a rotational speed of between 1 and 20 revolutions per minute, and typically between 3 and 12 revolutions per minute. Typically, the drive means comprises a motor.

The means for mounting the at least one light source conveniently includes a slip ring connection such that power can be fed to the at least one light source while it is being rotated around the object. This allows for the rotation of the at least one light source, while still being connected to a bench power supply. Alternatively, the at least one light source is a battery powered light source.

According to a convenient arrangement, the adjustment mechanism is capable of being activated to vary the height of the at least one light source relative to the object while the drive means is driving the at least one light source around the object. This results in the object being illuminated from a variety of heights and angles during the photoshoot, allowing for different visual effects to be obtained. Typically, the apparatus includes a motor for varying the height of the at least one light source relative to the object while the drive means is driving the at least one light source around the object.

Preferably, the apparatus includes two or more light sources, each light source being mounted such that it is capable of being moved around the object in a circular path. Typically, the adjustment mechanism is such that each the light source is capable of being mounted at a variety of different heights relative to the object. In this way, one light source can be rotated around the object at a first height, and a second light source can be rotated around the object at a second height with respect thereto. A variety of light sources at different angles can produce impressive visual effects. Other accessories such as reflectors and shades can also be mounted for rotation around the object, leading to an impressive number of variations, each with particular visual characteristics.

The camera is typically a stills camera with a shutter speed of between 1 and 10 seconds. However, the camera is alternatively a video camera, producing continuous moving images, or even a film camera. According to one conceivable arrangement, the camera is itself located on the mounting means such that it is capable of being moved around the object in a non-linear path, typically a circular path. In this arrangement the drive means drives both the camera and the one or more light sources around the object. The arrangement with the camera moving around the object is more suited to use with a video camera, although moving a stills camera with a slow shutter speed around the object can produce various artistic effects.

The invention further resides in a method of obtaining a high quality image of an object comprising the steps of
i) mounting the object on a stationary surface,
ii) mounting a camera such that it is pointing at the object,
iii) illuminating the object with one or more light sources,
iv) rotating the one or more light sources around the object,
v) modulating each of the one of more light sources such that the amount of illumination from each light sources varies as they are rotating around the object, and
vi) capturing an image of the object with the camera while the one or more modulated light sources are rotating around the object.

The modulation of the one or more light sources has the effect of illuminating the object for some parts of the revolution, while not illuminating the object for other parts of the revolution. This can once again produce various interesting visual effects and adds to the variety of types of image which can be produced by the apparatus of the present invention.

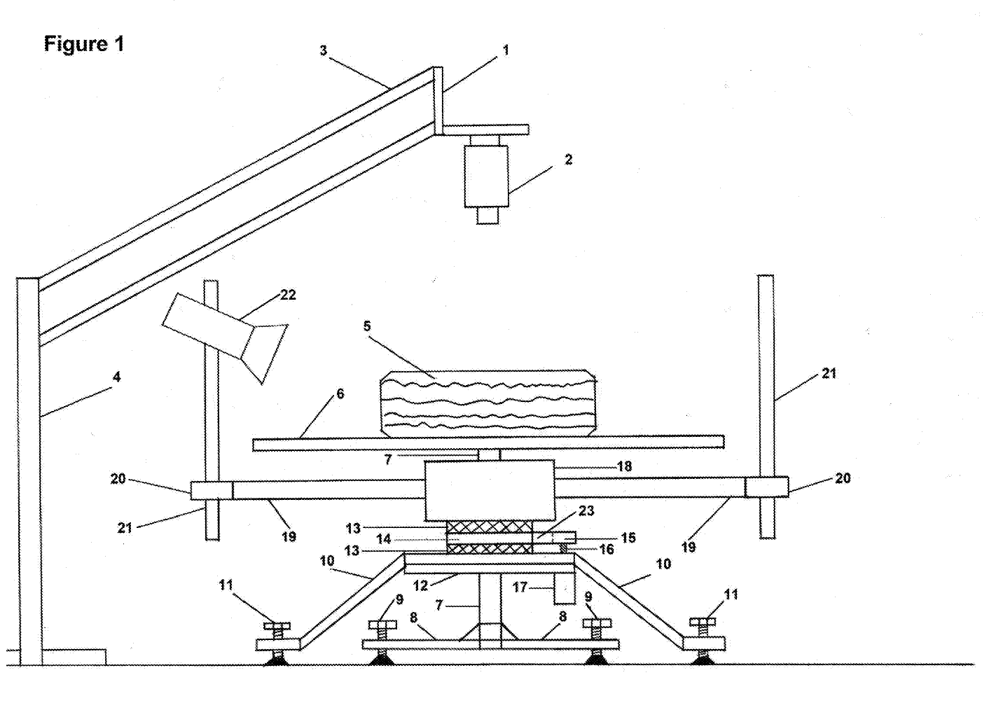

Referring to FIG. 1, a camera 2 which can be either a film, video, still camera or any other image capturing device, is attached to a mounting plate 1 which is mounted on a device to suspend the camera in mid-air, in the form of a crane 3 commonly used in the film industry. The crane 3 is attached to a stand 4. The subject 5 to be photographed is placed on a table surface 6 which is attached to a column 7 that is mounted on an arrangement of three horizontal legs 8 which are at one hundred and eighty degrees to each other. Only two legs 8 are shown in FIG. 1 for simplicity. Each leg has a levelling screw 9 that can be used to level the table surface 6.

In this instance the subject 5 is a car wheel with a tyre fitted laid on top of the table surface 6 on which a suitable background (not shown) has been placed. A hub 18 rotates around the central column 7, the mechanism consisting of two bearings 13 that are built into a separate unit so there is clearance between the column 7 and two rotating arms 19, which will be described in more detail subsequently. Alternatively, the bearings 13 can be attached directly to the central column 7.

A plate 12 is mounted on a shaft (not shown) which rotates the hub 18 via a pulley wheel mechanism 14, with a drive belt 23 turned by another pulley 15 which is in turn driven by a motor 17 mounted to the plate 12. The plate 12 is attached to an arrangement of three legs 10 which are at one hundred and eighty degrees to each other. Once again, only two legs 10 are shown here for simplicity. Each leg 10 has a levelling screw 11 that can be used to level the arms 19 so that they are parallel with the surface of the table 6.

The hub 18 houses a slip ring (not shown) to transfer power to a light source 22 along with additional switching controls (not shown). The hub 18 has the two fixed arms 19 attached. At the end of each arm is a clamping device 20 that clamps pylons 21 so that they can be set at any height, with different length pylons also being used to control the height of the pylons. Single arms can be used but it is preferable to use them in pairs with similar weights on each pylon to balance the system for a smooth rotation and less stress on the motor.

The single light source 22 is attached to the pylon 21, the position of the light source 22 being further adjusted by means of a clamp and arm not shown to simplify the drawing. Power is supplied to the light source 22 via cables (not shown) from the central hub 18 via the slip ring (not shown). Alternatively, the light source 22 can be powered directly by its own batteries. The central hub 18 contains an indexing mechanism (not shown) to reference the position of the rotating arms.

External power is transferred via cables to connectors (not shown) on the plate 12 to the slip ring (not shown). The power to the light source 22 can be direct from a suitable source or via a control box (not shown) to control the state of the light during rotation whether on, off or fading up and down. The speed of the motor 17 is controlled via a separate control box (not shown).

In use, the camera 2 is attached to the crane 3 and placed in a suitable position and angle at any point around the table surface 6 pointing in the direction of the subject 5. The camera 2 is then focussed on the subject 5 once the desired composition is achieved. The light source 22 is then adjusted to illuminate the subject 5 at a height and angle that the user considers best for a particular effect. The camera shutter is then set to an exposure equalling the time taken for the light source 22 to complete one complete revolution of the subject 5. At ten rpm each complete rotation of the arm takes six seconds, so in this example the camera shutter would be set at six seconds. The corresponding aperture and ISO is set on the camera either based on a calculation or testing to give the correct exposure.

Power is supplied to the motor 17 to drive the rotating arms 19. The speed of the motor and therefore the rpm of the rotating arms 19 is set via a control, box (not shown). An indexing system in the hub 18 is used to measure the actual rpm of the rig on the motor control box and also trigger the light source 22 if required via a separate lighting control box not shown.

The process is executed in a darkened studio/room so any house lights are now switched out and then the motor 17 is switched on. When the system is running at a constant six rpm, the camera shutter is fired remotely to take an exposure. During the six seconds the light source on the pylon completes a 360° path around the object. The camera shutter can be altered to create different effects for example if set at 9 seconds, the light source would create a brighter exposure on approximately one half of the subject.

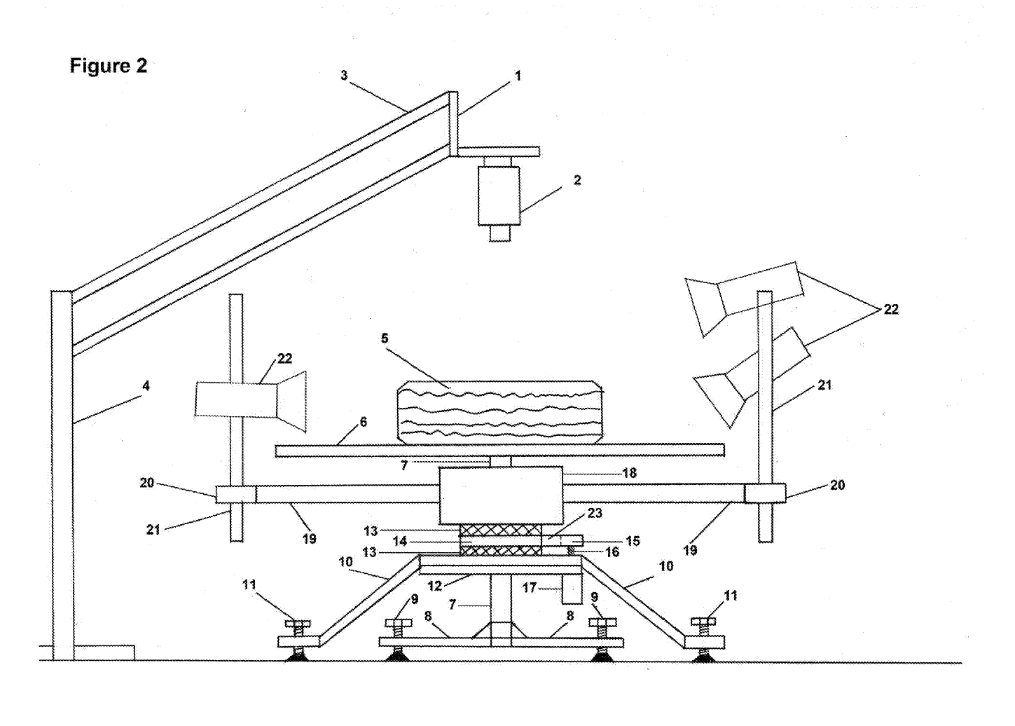

FIG. 2 shows a similar arrangement to that of FIG. 1, with similar components designated by the same reference numerals. The apparatus of FIG. 2 differs however, in that there is the addition of two extra light sources 22. The additional light sources are present on the pylon 21 and pointing in different directions to illuminate the background on support table 6 and different areas of the subject 5.

In use the arms 19 and hence the light sources 22 are rotated around the object 5 on the stationary table surface 6. This adds the possibility of a wider range of effects and different elements of the object 5 can be lit individually. It is possible to use a lighting control system (not shown) to turn the lights on and off during the exposure as well as fade them up and down at different points during rotation.

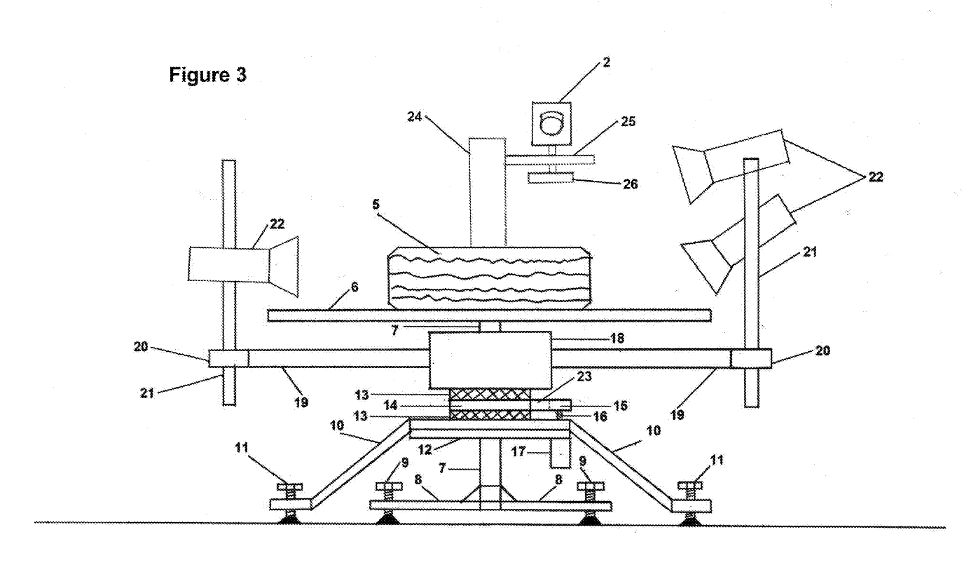

FIG. 3 shows an apparatus in which the camera 2 is not mounted on the crane 3, but mounted for rotation around the subject 5. The apparatus is provided with an additional arm 19 (not shown as its hidden behind the hub 18) at 90° to the two arms 19 showing. A vertical pylon 24 attached to this additional arm, and attached to the pylon 24 is a camera platform 25. The camera 2 is attached to this camera platform. This embodiment shows a motorised control system 26 to move the camera in any direction.

In use, a video camera 2 is attached to the camera platform 25 and placed in a suitable position pointing in the direction of the subject 5. The camera is then focussed on the subject 5 once the desired composition is achieved. The video camera 2 is moved by the motorised control system 26 which can tilt the camera up and down, and left and right if required. The motorised control system 26 can also control the focus and camera zoom, if required. The motorised control system is powered by batteries and controlled either wirelessly or by cables via the slip ring (not shown) in the hub 18.

The light sources 22 are adjusted to illuminate the subject and background at a height and angle that the user considers best for a particular effect. The video camera shutter is then set to an exposure balancing the corresponding aperture, shutter speed and ISO to give the correct exposure based on the level of illumination. The video camera 2 is switched on before the arms 19 start rotating as the moving image is to be edited after the shoot.

Power is supplied to the motor 17 to rotate the arms 19. A control box (not shown) varies the speed of the motor and therefore the rpm of the rotating arms 19. An indexing system (not shown) in the hub 18 measures the actual rpm of the rig on the motor control box and also triggers the light source if required via a separate lighting control box (not shown). The speed of the motor 17 is set to the required speed. If the object 5 is to be viewed moving slowly, an rpm of one or less could be used, but by adjusting the rpm to six a much quicker rotation of the object is achieved. Alternatively, the rpm of the motor can be adjusted during the rotation to slow down or speed up the shot.

As before, the process is executed in a darkened studio/room so that any house lights are switched out, and then the motor 17 is switched on. When the system is running at the required rpm, the camera shutter is fired remotely (if the camera has not already been switched on to take an exposure). During the six seconds of the exposure, the light sources 22 on the pylons 21 complete a 360° path around the object. By moving the camera from the crane 3 shown in FIG. 1 to the rotating pylon 24 a very different effect is created as the camera now moves around the subject 5 with the light sources 22, opposed to the subject 5 remaining stationary and the light sources 22 moving around it.

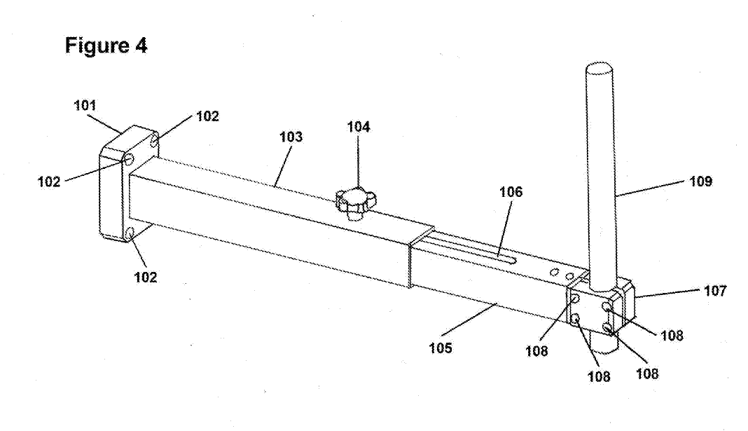

FIG. 4 shows an adjustable arm that can be attached to the central rotating hub 18. The plate 101 is attached to the hub using appropriate bolts inserted through four holes 102, one not shown. The tube 103 has a slightly smaller tube 105 inserted telescopically, which freely slides in and out of the outer tube 103. The tube 105 has a slot 106 machined into it to allow for a locking knob 104 to lock the arm 105 in a desired position. A machined component 107 is present at the end of tube 105, the component 107 clamping the pylon 109 in place using four bolts 108.

Once the adjustable arm is attached to the central rotating hub 18, the tube 105 is moved in or out to the required distance and locked in place using the locking knob 104. The pylon 109 is then slid through the clamp 107 to the required height then locked in place using the four bolts 108. In this way, the length of the arm 19 can be adjusted as desired.

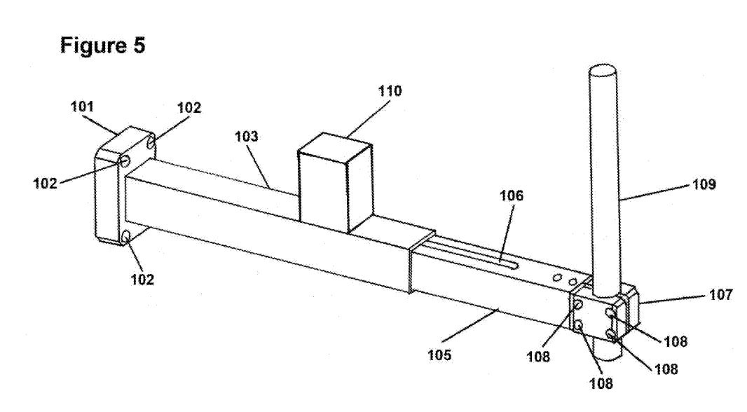

FIG. 5 shows a motorised version of the adjustable arm of FIG. 4, with similar components designated by the same reference numerals as in FIG. 4. In FIG. 5, the locking knob 104 has been replaced by a motor 110 and the tube 105 is driven by the motor 110 to slide the arm in and out. The motor 110 enables the pylon 109 with either a camera 2 or light source 22 attached thereto be moved in and out during the exposure. The motor 110 is controlled be a separate motor controller (not shown) manually or via software. This movement would effectively be equivalent to zooming the light(s) in and out or changing the perspective of the camera shot during the rotation.

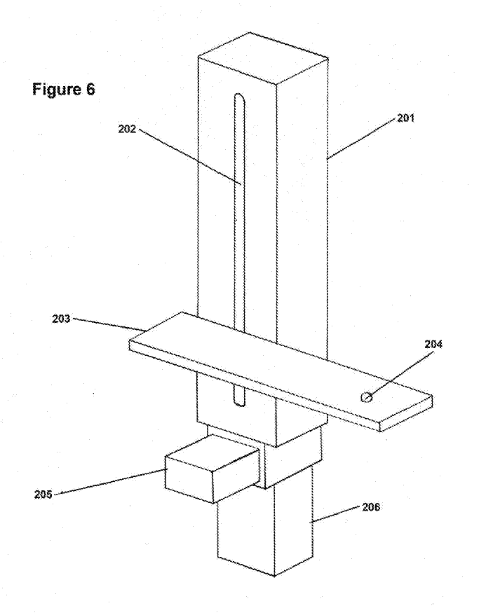

FIG. 6 shows a motorised arm 201 that can be attached to the end of one of the rotating arms 19 shown in FIG. 1 or to the arm 105 shown in FIGS. 4 & 5. A connector 205 is inserted into the end of the rotating arm 19 and clamped in position. A mounting platform 203 is provided, and a camera 2 or light source 22 can be attached to the mounting platform 203 by means of a threaded mounting hole 204. The camera or light source can be screwed directly to the mounting platform 203, or mounted via a separate pan/tilt head (not shown), which could also be motorised in the case of a camera being used. The platform 203 is driven by a motor/gearbox combination 206 housed within the unit 201. The motor 206 raises and lowers the platform 203 when activated, with the platform 203 being able to move up and down along slot 202.

In use, the position of the light source 22 or/camera 2 can be adjusted by activating the motor 206 either manually or using software as the system rotates around the central hub during the exposure. In this way, the height and or angle of the light source or camera can be adjusted, either between shots, or during a photoshoot. By combing this motorised pylon with the motorised arm of FIG. 4 and possibly also the addition of the motorised camera control 26 as shown in FIG. 3, a large number of effects can be produced during each rotation.

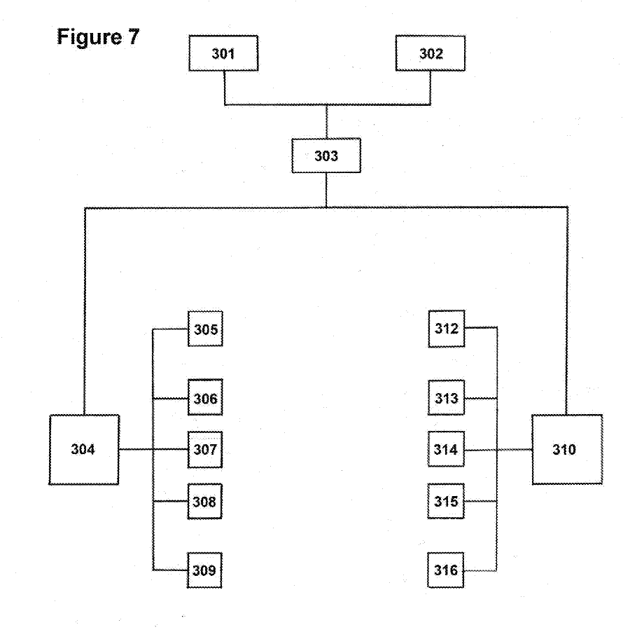

FIG. 7 is a schematic diagram showing the process of shooting an exposure or recording a moving image. The process can be started manually using a signal from a hand held trigger comprising of a simple push button switch 301 or alternatively by the signal from a sensor 302. The signal is processed through a circuit 303 and split and delivered to two or more control boxes, two being shown here for simplicity. Control box 304 is a motor control box which can turn motors on and off at any point during each revolution, as well as controlling the speed of revolution.

In this embodiment, several motors are used, motor 305 drives the motor/gearbox combination 17 in FIG. 1, while motor 306 drives the motorised arm shown in FIG. 5. Motor 307 drives the motorised pylon shown in FIG. 6, while motor 308 drives the focus on the camera. Finally, motor 309 drives the rotation of the table 19 shown in FIG. 1. Control Box 310 triggers the camera and controls the lights sources. The light sources from here can be faded up and down as well as being switched on and off at any point during the rotation. Similarly, the camera can be triggered directly from the control box 310 with any delay built in.

In this embodiment a number of light sources are used, and in this example channel 312 triggers the camera shutter on a stills camera or the record button on a moving image recorder. Channel 313 controls the light source 22 shown in FIG. 1, while channels 314, 315 & 316 control other light sources. These control systems allow any exposure to be based around a partial revolution, a full revolution or multiple revolutions.

Those skilled in the art will appreciate that many variations are possible without departing from the scope of the present invention. Different light sources can be used with the system to create different effects, including tungsten, HMI, flash, infrared, ultraviolet, sodium, LED sources or even candles. The table surface 6 can be motorised to rotate in either direction around the column 7. The rotating arm assembly can be rotated through ninety degrees and supported on a stand so that the arms rotate in a vertical plane rather than in a horizontal plane. The camera can then be placed looking through the central bore or alternatively a tube can be inserted through the central bore and held in position via a stand behind the rotating arm arrangement.

Other variations include inverting the arms such that they are rotated through one hundred and eighty degrees and supported on a different stand arrangement. In this case, the arms are rotating in a horizontal plane but pointing down towards the surface 6 at ground level with the surface 6 containing the object 5. The camera 2 can then be placed on a separate stand looking through a central bore.

The arms 19 can be replaced by a suitable track system, which is constructed around the subject 5. One or more motorised carriages are moved around the track, with the carriages carrying the light sources 22 or indeed the camera 2. The light sources 22 or the camera 2 could conceivably even be attached to a drone flying around the object.

1. Apparatus for capturing a still or moving image of an object, the apparatus comprising;
a) a camera pointed at the object;
b) at least one light source illuminating the object;
c) means for mounting the at least one light source such that it is capable of being moved around the object in a non-linear path, the mounting means including an adjustment mechanism allowing the at least one light source to be mounted at a variety of different heights relative to the object; and
d) drive means for driving the at least one light source around the object.

2. Apparatus according to claim 1, wherein the at least one light source is mounted on an arm which is movable about the object.

3. Apparatus according to claim 2, wherein the arm is provided with adjustment means so as to vary the distance of the light source from the object.

4. Apparatus according to claim 3, including a motor for activating the adjustment means so as to vary the distance of the light source from the object while the drive means is driving the at least one light source around the object.

5. Apparatus according to claim 4, wherein the motor activates the adjustment means such that the at least one light source is moved around the object in an elliptical path.

6. Apparatus according to claim 1, wherein the mounting means is such that the at least one light source can be moved around the object in a circular path.

7. Apparatus according to claim 1, wherein the apparatus includes a stationary platform on which the object can be placed, with the drive means driving the at least one light source around the platform.

8. Apparatus according to 1, wherein the drive means drives the at least one light source around the object at a rotational speed of between one and twenty revolutions per minute.

9. (canceled)

10. (canceled)

11. Apparatus according to claim 1, wherein the means for mounting the at least one light source includes a slip ring connection such that power can be fed to the at least one light source while it is being rotated around the object.

12. (canceled)

13. Apparatus according to claim 1, wherein the adjustment mechanism is capable of being activated to vary the height of the at least one light source relative to the object while the drive means is driving the at least one light source around the object.

14. Apparatus according to claim 13, including a motor for varying the height of the at least one light source relative to the object while the drive means is driving the at least one light source around the object.

15. Apparatus according to claim 1, including two or more light sources, each light source being mounted such that it is capable of being moved around the object in a circular path.

16. Apparatus according to claim 15, wherein the adjustment mechanism is such that each the light source is capable of being mounted at a variety of different heights relative to the object.

17. Apparatus according to claim 1, wherein the camera is a stills camera with a shutter speed of between one and ten seconds.

18. Apparatus according to claim 1, wherein the camera is a video camera.

19. Apparatus according to claim 1, wherein the camera is a film camera.

20. Apparatus according to claim 1, wherein the camera is located on the mounting means such that it is capable of being moved around the object in a non-linear path.

21. Apparatus according to claim 6, wherein the camera is located on the mounting means such that it is capable of being moved around the object in a circular path.

22. Apparatus according to claim 20, wherein the drive means also drives the camera around the object.

23. A method of obtaining a high quality image of an object comprising the steps of
i) mounting the object on a stationary surface,
ii) mounting a camera such that it is pointing at the object,
iii) illuminating the object with one or more light sources,
iv) rotating the one or more light sources around the object,
v) modulating each of the one of more light sources such that the amount of illumination from each light sources varies as they are rotating around the object, and
vi) capturing an image of the object with the camera while the one or more modulated light sources are rotating around the object.
